(19) United States
(12) Patent Application Publication
(10) Pub. No.: US 2010/0205017 A1
(43) Pub. Date: Aug. 12, 2010

(54) Automated Transportation Call-Taking System

(75) Inventors: Ted M. Sichelman, San Diego, CA (US); James M. Kennedy, III, Oak Park, CA (US); Jefferson P. Nunn, Malibu, CA (US); Joseph J. Oh, New York, NY (US); Roberto C. DeGennaro, Brooklyn, NY (US); Darren Malvin, Westlake Village, CA (US); Jason T. Tepper, New York, NY (US)

Correspondence Address: PATENTBEST, 4600 ADELINE ST., #101, EMERYVILLE, CA, 94608, US

(73) Assignee: UNIFIED DISPATCH, LLC, Altadena, CA (US)

(21) Appl. No.: 12/699,854

(22) Filed: Feb. 3, 2010

Related U.S. Application Data
(63) Continuation of application No. 10/365,704, filed on Feb. 11, 2003.
(60) Provisional application No. 60/356,255, filed on Feb. 11, 2002.

(51) Int. Cl. G06Q 50/00; G06Q 10/00; H04M 1/64; H04M 3/00

(52) U.S. Cl. 705/5; 705/8; 705/30; 705/345; 379/88.04; 379/265.09

(57) ABSTRACT

An automated, scalable call-taking system integrates with existing telephony infrastructures and enables, through use of speech recognition, DTMF detection, text-to-speech (TTS), and other related software or hardware, the inputting, access, and retrieval of information to and from multiple back-end dispatch and booking systems without the need for a human operator.

### CROSS REFERENCE TO RELATED APPLICATIONS

This application claims the benefit of provisional application 60/356,255, filed Feb. 11, 2002, and incorporated by reference herein in its entirety.

### COPYRIGHT NOTICE

A portion of this disclosure contains material in which copyright is claimed by the applicant. The applicant does not object to the copying of this material in the course of making copies of the application file or any patents that may issue on the application, but all other rights whatsoever in the copyrighted material are reserved.

### BACKGROUND OF THE INVENTION

1. Field of the Invention

The present invention relates generally to an automated system for inputting, accessing, and retrieving speech- and touch-tone (DTMF) based information for processes related to passenger ground transportation through an ordinary or Voice over IP (VOIP) telephone using specialized voice recognition software and hardware.

2. Description of the Related Art

For a number of years, many industries have employed telephone-accessible automated information systems that provide callers with an ability to input and retrieve information without operator interaction. For example, most banks provide automated systems for providing account-related information, such as balance, checks paid, and deposits.

The passenger ground transportation industry (e.g., taxicabs, limousines, shuttles, paratransit, buses, trains, etc.), however, has not widely deployed robust speech recognition or touchtone-based systems for a number of reasons. First, groups in the field have been unable to produce the logical structures needed to handle the multiple types of transactions encountered in dispatch and call centers. Second, there has been an inability to produce reliable middleware that allows easy integration to multiple third party back-end legacy booking and dispatch systems. Third, conventional systems typically fail to integrate to the existing third party telephony infrastructures of the dispatch and booking centers, thereby precluding scalability and ease-of-use. In particular, by failing to integrate to existing telephony infrastructure, passengers are forced to access automated systems via unique phone numbers, which need to be separately learned or catalogued, thereby reducing ease-of-use. Fourth, because they are written in proprietary programming languages, conventional systems are typically limited to one set of digital signal processing hardware, e.g., Dialogic. Fifth, conventional systems do not allow for easy integration to existing Internet-based protocols and standards, which allow further scalability. Sixth, current speech applications dealing with the capture of street addresses and other location-based information are generally plagued with lower accuracy rates than other speech recognition processes. The difficulty generally arises from the large grammars that are needed to recognize a street name.

Nonetheless, there exists a strong need in the passenger ground transportation industry to provide automated access and input ability to prospective passengers. Automated access allows a transportation provider to reduce dependence on human dispatchers and agents, thereby reducing costs and human error involved with data entry. Automated systems further decrease abandoned calls and increase the number of new service calls by offering a faster and easier method of inputting and accessing necessary information, especially when telephone hold times are taken into account. This is especially critical during peak demand periods, such as rush hour, weekends, or holidays.

In view of the foregoing, a need therefore exists for an automated system that provides for the inputting and accessing of speech- and touchtone-based information over conventional and VOIP telephone links, which further meets the needs of the various types of transactions encountered in the passenger ground transportation industry, integrates to the various back-end dispatch, booking, and telephony architectures encountered in the industry, and provides for scalability and robustness across a variety of implementation types.

### SUMMARY OF THE INVENTION

The present invention satisfies the foregoing need by providing an automated, scalable call-taking system that integrates with existing telephony infrastructures and that enables, through use of speech recognition, DTMF detection, text-to-speech (TTS), and other related software or hardware, the inputting, access, and retrieval of information to and from multiple back-end dispatch and booking systems without the need for a human operator.

The present invention allows passengers to access a telephony gateway that performs initial speech recognition and DTMF processing, TTS and audio playback, and call control functionality (such as recognizing automatic number identification (ANI), Caller ID (CUD), and dialed number identification (DNIS)). The telephony gateway may be accessed over the traditional public switched telephone network (PSTN) or IP networks depending upon an end-client's existing telephony infrastructure.

An application speech server contains logic to process the various transactions encountered in a passenger ground transportation dispatch center. These include, for example, (i) ordering a vehicle, including inputting of address, time, and other relevant information; (ii) gathering information in real-time about available vehicles (including location, availability, and type); (iii) gathering information about rates for proposed trips, times, and vehicles; (iv) checking on the status of a vehicle in real-time; (v) advance payment with credit card or voucher; (vi) requesting a particular driver; (vii) choosing from among various vehicle types having varying pricing and availability information; (viii) advance reservation features; and (ix) selecting notification for trip confirmations, ETAs, other updates, and lists of recent trips with past fare information.

The speech server is in real-time communication with multiple back-end fleet dispatch and booking systems, enabling many of the types of transactions typically undertaken by a human dispatcher or agent. The present invention also includes a logging and reporting mechanism, whereby information generated can be viewed in real-time or logged for further review and analysis.

If the automated system is unable to handle the caller's request, the call may be transferred to a dispatcher, agent, or ACD/workgroup by a number of methods described herein. Additionally, through computer telephony integration (CTI) to the call center's private branch exchange (PBX) and/or automatic call distribution (ACD) system, an agent or dispatcher can immediately view any information already inputted by the caller into the speech server or that is stored in customer profile databases.

Once a transaction is complete, third party back-end dispatch performs further processing, including transmitting captured information to vehicles, storing information for analysis by human dispatchers, and transmitting payment information for verification.

### BRIEF DESCRIPTION OF THE DRAWINGS

FIG. 1 is a block diagram of a system in accordance with an embodiment of the present invention.

FIG. 2 is a block diagram illustrating the use of overflow hardware and software located at a centralized data center in accordance with an embodiment of the present invention.

FIG. 3 is a block diagram illustrating an alternative embodiment of a system in accordance with the present invention.

FIG. 4 is a block diagram illustrating an alternative embodiment of a system located at a centralized data center in accordance with an embodiment of the present invention.

FIG. 5 is a flow diagram illustrating a “Main Menu” call flow process in accordance with an embodiment of the present invention.

FIG. 6 is a flow diagram illustrating a “Main Menu” call flow process in accordance with an embodiment of the present invention.

FIG. 7 is a flow diagram illustrating an “Other Inquiries” call flow process in accordance with an embodiment of the present invention.

FIGS. 8A and 8B are call flow diagrams illustrating a “Taxi Order” call flow process in accordance with an embodiment of the present invention.

FIG. 9 is a call flow diagram illustrating an “Address Capture” call flow process in accordance with an embodiment of the present invention.

FIG. 10 is a call flow diagram illustrating a call flow process in which a caller is transferred to an agent in accordance with an embodiment of the present invention.

FIG. 11 is a call flow diagram illustrating a call flow process in which a caller is transferred to an agent in accordance with an embodiment of the present invention.

FIG. 12 is a call flow diagram illustrating a call flow process in which a caller is transferred to an agent in accordance with an embodiment of the present invention.

FIG. 13 is a call flow diagram illustrating a call flow process in which a caller is transferred to an agent in accordance with an embodiment of the present invention.

FIG. 14 is a call flow diagram illustrating a “Fare Information” process in accordance with an embodiment of the present invention.

FIG. 15 is a block diagram illustrating the use of a Legacy Application Bridge in accordance with an embodiment of the present invention.

### DETAILED DESCRIPTION OF THE PREFERRED EMBODIMENTS

### System Architecture

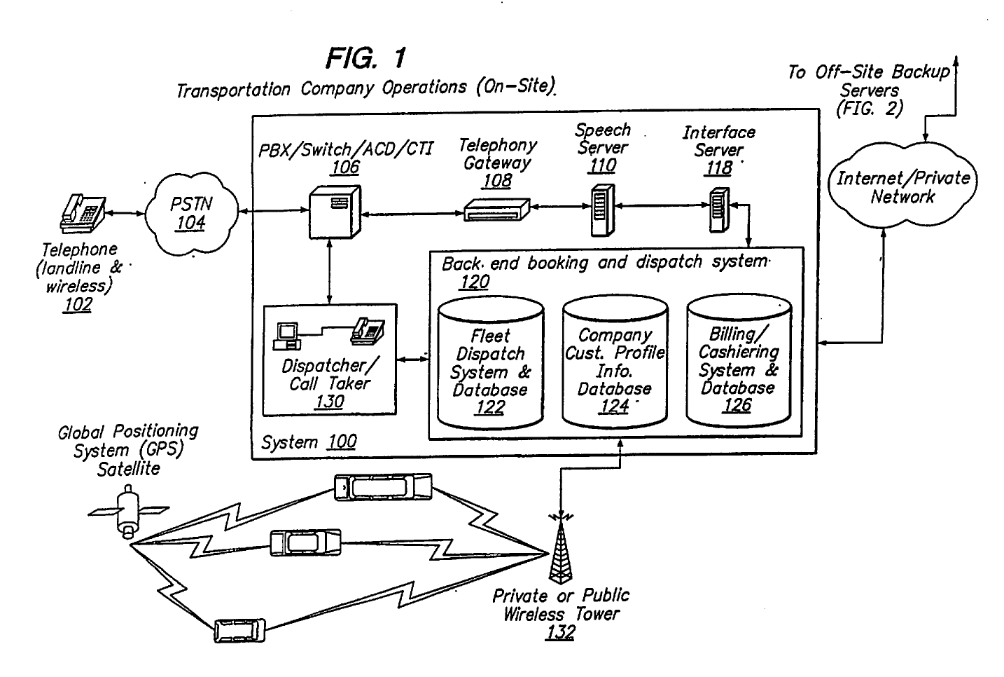

Referring now to FIG. 1, there is shown a system 100 that includes functional components of a preferred embodiment of the present invention. System 100 includes a standard PBX telephone system 106 or other similar switch, along with optional computer telephony integration (CTI) or automatic call distribution (ACD) components. Additionally, system 100 includes a telephony gateway 108, speech server 110, and interface server 118, as described below. On the back-end of system 100 is a booking and dispatch system 120, which includes a fleet dispatch system and database 122, a company customer profile information database 124, and a billing and cashiering system database 126. The back-end booking system is connected to a dispatcher or call taker 130, and to additional dispatch technology, such as a private or public wireless tower 130.

The figures depict preferred embodiments of the present invention for purposes of illustration only. One skilled in the art will readily recognize from the following discussion that alternative embodiments of the structures and methods illustrated herein may be employed without departing from the principles of the invention described herein.

In a preferred environment, a caller using a telephone 102 initiates a telephone call, which is routed via a PSTN 104 to the transportation company operating system 100. Alternatively, telephony gateway 108 and speech application server 110 components of the present invention may be utilized to place outbound calls from system 100 to a caller.

In order to provide scalability, ease-of-use, and integration with existing infrastructure, the telephony gateway 108 is connected via a standard telephony interface to a private branch exchange (PBX) telephone or similar system 106 located at the client transportation company. Thus, a client may use the same sets of phone numbers presently in operation to implement the present invention. The means of interface is accomplished, for example, through a robbed bit T1 (CAS), ISDN-PRT, or analog signaling card placed into the PBX 106 and connected via suitable cables to the telephony gateway 108 into a similar such card. Through conventional telephony protocols, the PBX 106 and telephony gateway 108 are then coordinated so that traditional call control features, such as connect, disconnect, supervised and unsupervised transfer, conference, and so forth, become available to the speech server 110 in conjunction with the PBX 106. For more robust PBX systems, advanced signaling, such as Q.SIG, becomes available as well. This signaling allows for full integration between system 100 and existing telephony architectures.

The telephony gateway 108 accomplishes call control, speech and DTMF processing, ANI/DNIS detection, and other related telephony functions through the use of a suitable digital signal processing (DSP) card such as the Dialogic JCT. Given that the speech server application 110 may be written in either an open standards language, such as Voice XML, or directly utilize proprietary APIs (e.g., Dialogic, NMS, etc.), the particular choice of DSP is not limited to a specific vendor.

When a call is received at PBX 106, the PBX determines the ANI and DNIS, and based upon an end-client's pre-defined business rules, routes the call either a live dispatcher/agent 130 or to the telephony gateway 108. Such business rules may include routing by ANI, DNIS, time of day, day of week, month of year, average hold time, or any other similar factors well known in the field. In the event the PBX 106 includes automatic call distribution (ACD) software, typically the ports of the telephony gateway 108 are configured as resources within a particular ACD group, so as to allow easy configuration, monitoring, and advanced routing capability. For instance, in the event all available ports of the telephony gateway are in use, callers may be queued at the PBX 106 for use of the automated call taking system.

After the caller is transferred to the telephony gateway 108, the caller's ANI and DNIS are detected and transmitted to the speech application server 110 via a standard network connection on a LAN. The speech application server 110 then retrieves and loads from a resident application a particular “call flow,” or series of potential logical questions, responses, and other steps necessary to mimic the logic used by human dispatchers and agents to handle various requests for and delivery of information relating to ground transportation service. Various call flows may be loaded based on ANI, DNIS, time of day, day of week, vehicle availability, location of caller, and other suitable factors. The call flow then supplies information to the caller 102 and directs responses as needed. A description of various call flows that may be undertaken are described in detail below under “Call Flow Description.”

The speech application server 110 via the telephony gateway 108 collects the caller's queries and responses, responds to them as needed, and transmits information in a real-time, two-way fashion via an interface server 118 to a backend dispatch and booking engine 120, which typically includes a fleet dispatch system and database 122, customer profile database 124 and financial and cashiering system and database 126. The interface server 118 preferably connects to the back-end systems 120 via a standard LAN connection, typically via router and through a firewall (not shown). In the event certain information is not available from the client transportation company databases 122, 124, 126, third party databases may be queried. For instance, if a particular phone number does not match a returned record, a third party phone number to street address database may be queried for the missing information. In this way, the customer information needed to book an order, respond to a status request, and so forth is collected and transmitted to the caller and backend system 120 as required. A description of the mechanism wherein the backend integration is accomplished is described in detail below under “Interface & Middleware Description”.

After the interface server 118 relays the information to the backend servers 120, there may be interaction between dispatch system 122 and vehicles in the field using wireless data networks 132 and vehicle mobile data terminals (MDTs) or two-way voice radios. System 100 allows for either method of transmission of data to the vehicle by enabling integration to multiple third party back-end dispatch and booking engines. For instance, once order information is captured, it is transmitted via wireless radio frequencies by human dispatcher or automated data dispatching systems to a vehicle or groups of vehicles. These vehicles may be located by global positioning systems (GPS) or other similar location-detecting methods.

Once a trip has been assigned to a vehicle via the back-end dispatch system 120, a caller 102 may retrieve vehicle and trip status information by calling back to the telephony gateway 108 and speech application server 110. Alternatively, the caller 102 may request to be notified by the speech application server 110 when a vehicle arrives, is within a certain or time or distance, and so forth. Related information, including error events, that occurs during the process of the caller's interaction with the system is stored for later analysis and reporting, as described below under “Logging Description”.

In the event a caller needs or desires to be transferred to a human dispatcher or agent 130, telephony gateway 108 transfers the caller to the appropriate person or ACD/workgroup using conventional methodology such as an unsupervised flash hook transfer, whisper transfers or conferencing. Via standard signaling protocols, the telephony gateway 108 may pass the ANI or a caller-entered callback phone number via the CLID/ANI channel along with the transfer. Through the use of standard computer telephony integration (CTI) protocols and interfaces to PBX systems, additional data fields may be passed via the interface server 118 to the dispatcher or agent's terminal 130. Once the dispatcher or agent completes the transaction, the dispatcher or agent may transfer the caller back to the automated system or simply hangs up to complete the call.

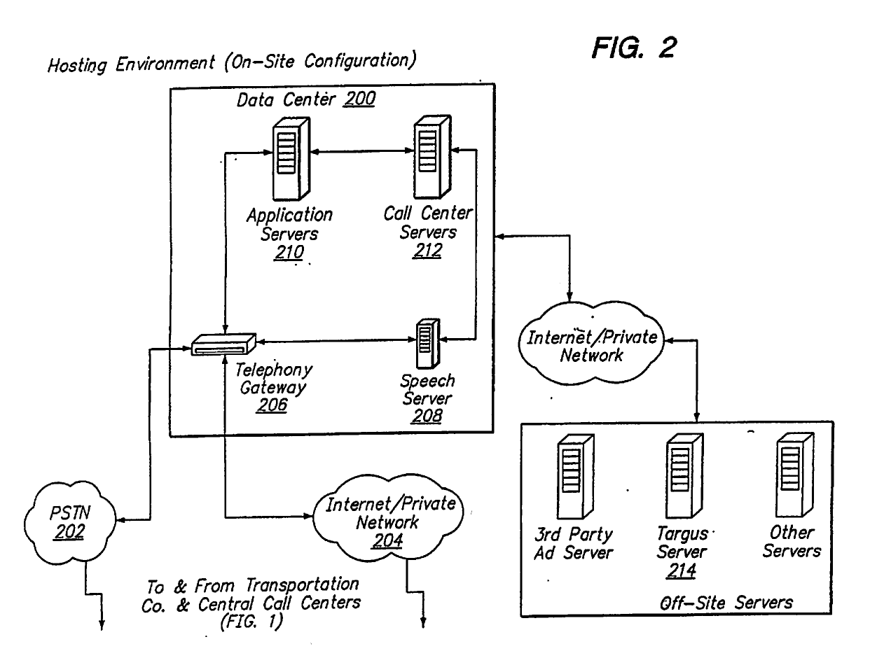

FIG. 2 depicts redundant and overflow hardware and software located in a centralized data center 200 in accordance with an embodiment of the present invention. In the event of a system failure or capacity limitation at the transportation company site running system 100, either the PBX telephone system 106 or the telephony gateway 108 transfers the call to the data center 200 via the PSTN 202 or via an IP 204 connection. At the data center 200 is a redundant telephony gateway 206 and speech server 208, which allow for similar processing of the call as on-site. ANI and DNIS are used to retrieve and load the appropriate call flow parameters for the transferred caller.

Additional application servers 210 may be located at the data center 200 and used for application enhancements. For example, application servers 210 may include XML and HTML servers; advertising servers for playing advertisements to callers during calls; a central booking server, which allows all booking and other trip details to be stored in a central repository for redundancy and logging purposes; and a softswitch server 210, which controls various optional Voice over IP (VOIP) gateways that allow client operations to connect to the data center 200. A call center server 212 controls routing and other call control functions between the data center 200 and client sites, as well as among client sites. Data center 200 may also have additional servers either onsite or available for access from third-party off-site locations. These additional servers include, for example, a Targus server 214, available from Targus, Inc. of Anaheim, Calif. Server 214 allows for the delivery of location-based information, such as addresses, latitude/longitude, and other customer profile information, including marketing characteristics (such as expected household size, income, buying patterns, and so forth); and data servers to provide airline flight schedules, geographic information systems, and weather & traffic conditions.

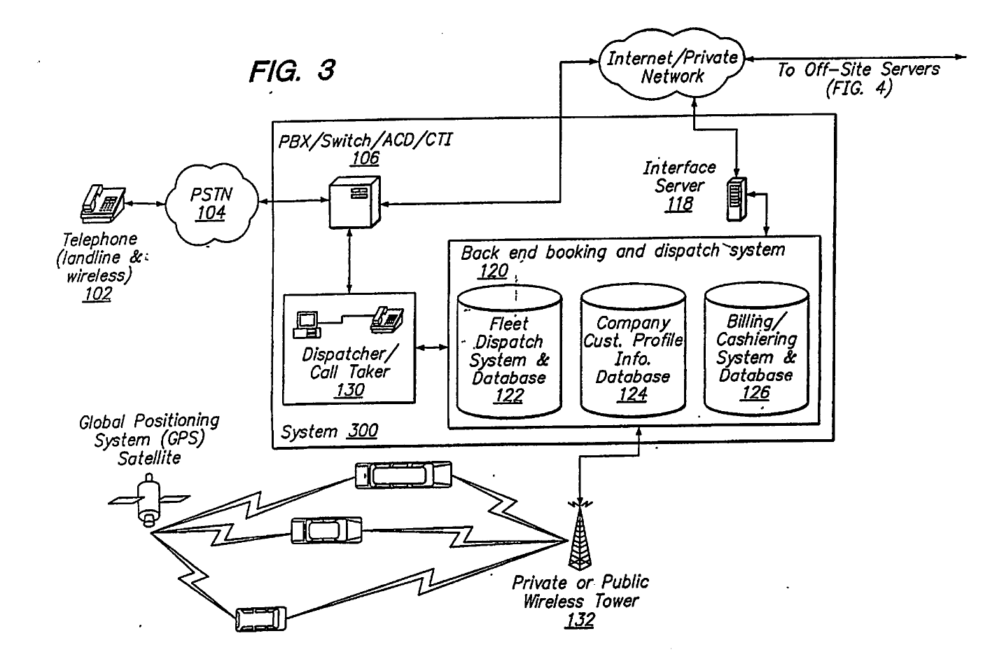

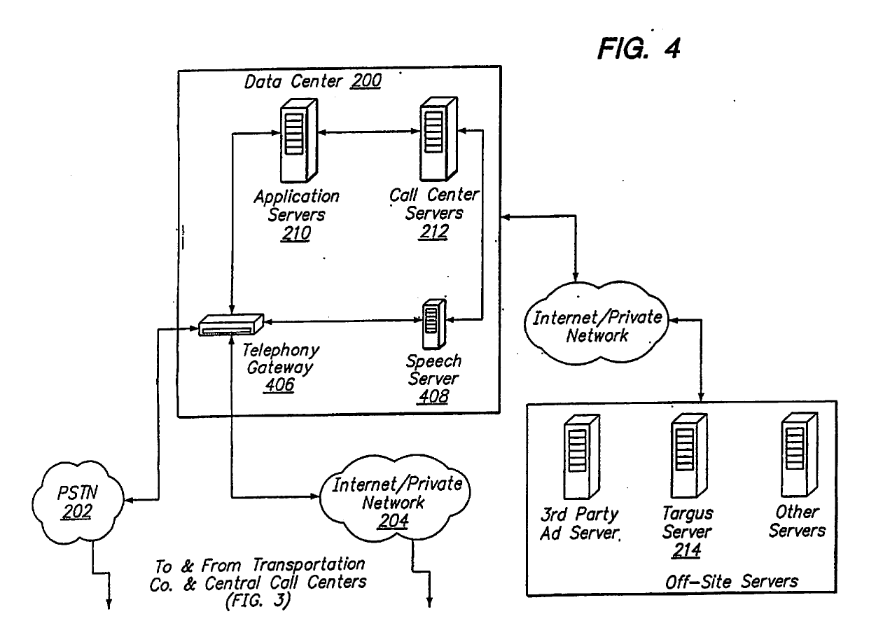

FIGS. 3 & 4 illustrate an alternative embodiment of the present invention in which the telephony gateway and speech server are located exclusively at the data center 200, instead of at both the client and the data center. As is shown in FIG. 3, when a passenger calls a transportation company's phone number, the caller is either routed to the data center 200 at the telecommunications carrier level or via the PBX 106 or a VOIP gateway located at the client transportation company's site. The call is then processed at the data center 200 according to the same call flows and logic as described above. Relevant data is transferred to and from the front-end servers by means of interface server 118, which may reside at the data center or on a client site (depicted in FIG. 3 as residing at the client site as part of system 300). When a caller desires to be transferred to a human dispatcher or agent, the call is sent via the carrier or the VOIP network to the client site and handled as usual. This hosted embodiment provides for quicker installation, easier supervision and maintenance, and in many cases, lower ongoing costs.

### Call Flow

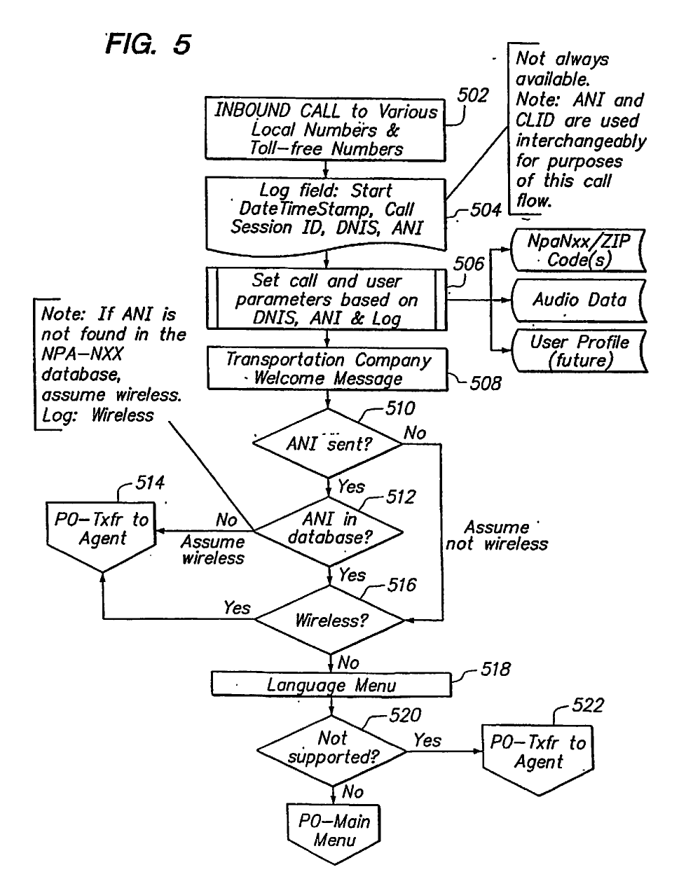

FIG. 5 shows an example of the logical call flow diagram of the process when a caller first dials into an application relating to passenger ground transportation. The caller may dial a standard local phone, toll-free number, or IP-based phone number.

When the caller enters 502 the system, the caller's DNIS (and sometimes ANI) will be logged 504 and used to retrieve 506 a specific “Call State Object” for each caller. In one embodiment the Call State Object includes ANI; DNIS; passenger account no.; passenger name; passenger account details (addresses on files, vehicle preferences, etc.); inbound telephone numbers for the local transportation company called (transportation company order-on-demand phone telephone number, reservations number, reservations change number, fare information number, customer service number, and corporate office number, as well as an associated set of sound files to be played based on DNIS); and routing instructions (such as routing by time of day and other preferences (e.g., whisper, supervised transfer, etc.)). Information that is not immediately accessible from the telephony gateway for each caller and each transportation company is either retrieved via the interface server from a back-end database or stored in an additional database on-site or in a centralized data center.

Based upon the caller's ANI and DNIS (and other factors, such as time of day, day of week, average hold time, and so forth), specific sound files are loaded and played 508 to the caller. For instance, in the event the caller dials for the Yellow Cab Co., the caller may hear “Welcome to Yellow Cab!” or if the caller dials for the Metro Limousine Co., the caller may hear “Welcome to Metro Limo!” and so forth. Other sound prompts and application logic may be specified in a similar manner.

Once a Call State Object is formed, then if 510 an ANI is present, the retrieved phone number is compared 512 against a database of phone number and location information to determine the approximate location of the caller, including city, state, and zip code, and whether the caller is dialing from a wireless device. If the ANI does not return a valid match against the database, an error is thrown and the caller is transferred 514 to a human agent for further processing. In an alternative embodiment, the caller might be queried to confirm the ANT or enter a new phone number. Similarly, if the ANI is 516 wireless, the caller is transferred 514 to a human agent for further processing. In the event that address-based speech recognition is active (or an address is not necessary to complete the transaction), however, the caller is allowed to continue on the call flow for further processing. Finally, if no ANI is present, the caller is later queried for a valid callback telephone number.

Next the caller is queried 518 to provide an indication of his or her native language through DTMF or speech recognition. This prompt may be skipped in the event a vast majority of callers speak a particular language. In the event the caller speaks a language not supported 520, the caller is transferred to a human agent. Based upon the caller's specified choice of language, the caller may be transferred 522 to a particular agent or workgroup that has the requisite language skills.

Throughout all the call flows, appropriate measures are taken in the event no entry or utterances are made by the caller. The caller is either re-prompted for entry, or after one or more non-entries, transferred to a human agent for further processing. Similar re-prompting or transfers occur upon incorrect or invalid entries. For instance, in the event of a timeout on the language menu, the caller is transferred to an agent. Further, global keys allow for a caller to replay a menu, access help files, or transfer to an agent throughout the call flow.

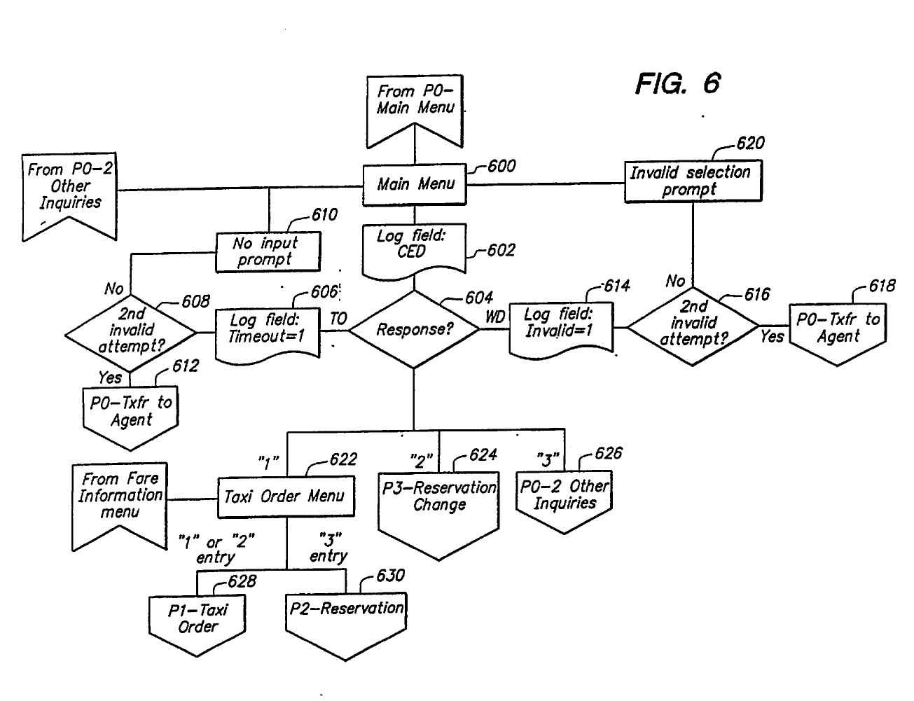

FIG. 6 illustrates a main menu portion of a call flow, in accordance with an embodiment of the present invention. At the main menu, a caller is prompted 600 to make a menu selection. In a preferred embodiment, choices include Taxi Order; Reservation Change; and Other Inquiries. Those of skill in the art will recognize that a variety of options can be offered to callers, depending on the business needs of the service provider. After the caller provides 602 a response, or alternatively, if a timeout occurs, the response/timeout is interpreted 604. If no response was provided (i.e. a timeout occurred) 606, and this is the second time 608 a timeout has occurred, the caller is transferred 612 to an agent. If it is the first time the timeout has occurred 608, the caller is alerted 610 that no input was received, and is returned to the prompt 600. If the input received is invalid 614, and it is the second time 616 an invalid response has been received, the caller is transferred 618 to an agent. If it is the first time 616 an invalid response has been received, the caller is alerted 620 that the response was invalid, and is returned to the prompt 600.

If the response 604 is valid, then the caller is directed along the call flow according to the response received. For example, in a preferred embodiment, if the caller selects the number “1”, he is presented 622 with a “Taxi Order Menu” prompt, from which in turn he can choose a Taxi Order 628 or Reservation 630 submenu. If the caller selects the number “2”, he is presented 624 with a “Reservation Change” submenu, and if he chooses “3”, he is presented 626 with the “Other Inquiries” submenu.

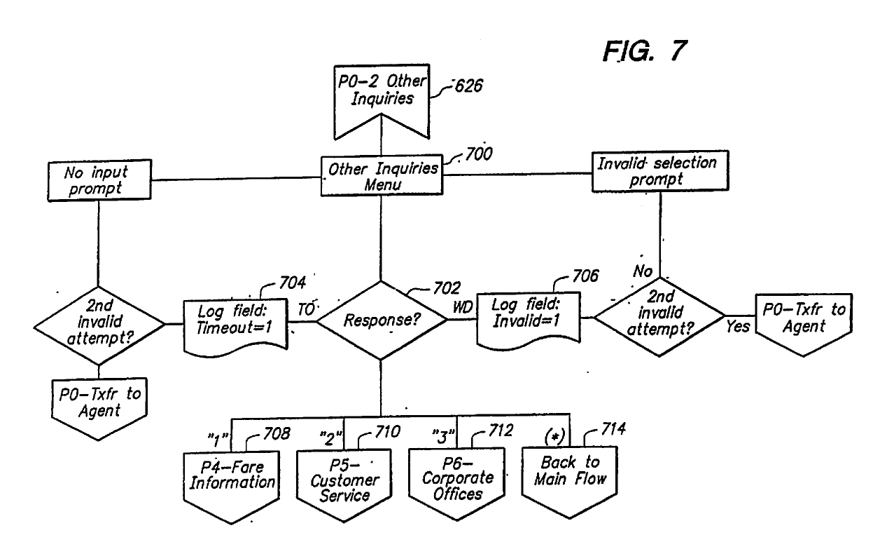

Referring now to FIG. 7, when the caller has selected 626 (FIG. 6) the “Other Inquiries” submenu, he is presented 700 with the Other Inquiries prompt. The user provides a response 702, which is tested for timeout 704 or invalidity 706, in a manner analogous to that described above with respect to FIG. 6. If the response 702 is valid, then the selection is processed. In a preferred embodiment, valid selections from the “Other Inquiries” menu include “Fare Information” 708, “Customer Service” 710, “Corporate Offices” 712, and “Back to Main” 714. Again, those of skill in the art will recognize that the selections offered to the caller will vary from enterprise to enterprise.

Fare information 708 allows a caller to retrieve general fare information; such as flag fees, distance fees, time fees, and extras. Additionally, by specifying a starting and ending point, callers can retrieve more exact fares based upon an estimated driving distance and time. By choosing the customer service choice 710, a caller is connected to a specialized agent to lodge a complaint, reach lost-and-found, or speak to accounts & billing. A corporate offices selection 712 connects to the caller to the transportation company's main business offices. Additionally, the caller may choose simply to return 714 to the main menu.

Those of skill in the art will also appreciate that while the description has so far assumed that a caller chooses various possibilities through DTMF, i.e., touchtone entry, in alternative embodiments, each of these menus can be adapted to allow for voice-entry (e.g., by saying “taxi,” “order,” etc.). For instance, at the main menu 600 (FIG. 6), the caller may select his or her choice via speech recognition. For example, to order a taxi, the user states “taxi”. For other inquiries, such as a status check, the user states “other”. Finally, to connect to an agent, the user states “operator”. Similar replacement of numerical choices with short words may be used to create speech-based entry on the various menus described herein. Alternatively, the user may be prompted simultaneously for either a speech or touchtone method of entry

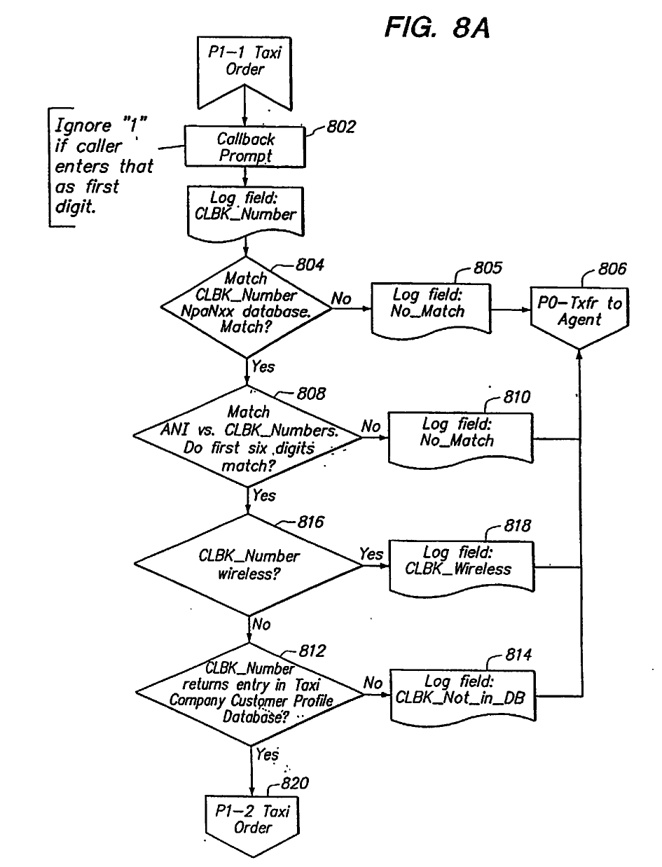

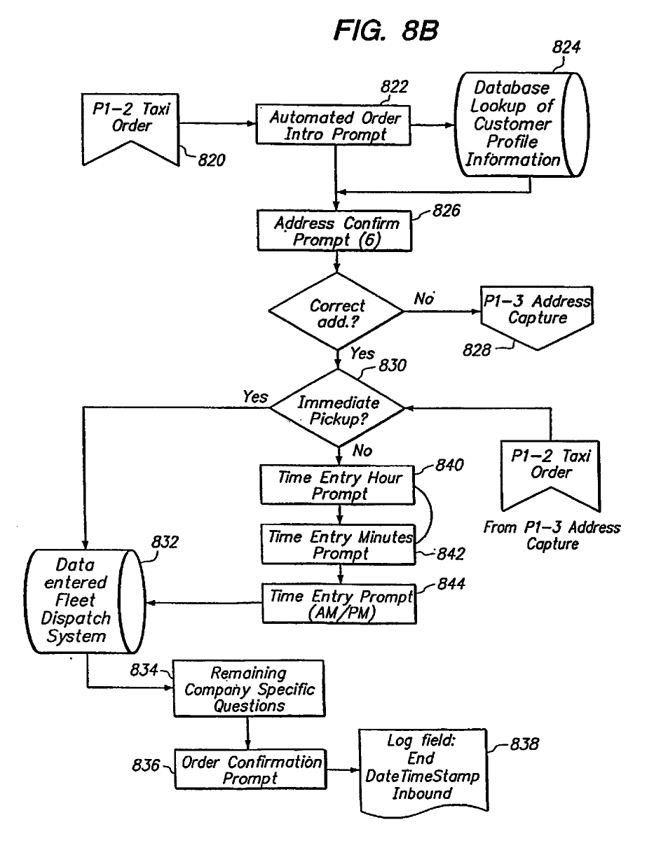

FIG. 8A illustrates a first series of steps in placing an order for a vehicle. In the event there is no ANI, an invalid ANI, or a desire to validate ANI, the user is prompted 802 for a callback number, which may be entered using DTMF or spoken. As with the ANI, the caller-entered callback number is then compared 804 with a database of valid phone numbers and associated locations. If there is no match 805, then the caller is transferred 806 to an agent. Alternatively, the validity of the caller may be taken for granted and the caller may continue with the call flow. Next, an optional double-check may be performed comparing 808 ANI with the caller-entered callback number. If the two do not match 810, the caller may again be transferred 806 to an agent. Further, if 816 the callback number is wireless 818, the caller may be transferred 806 to an agent (in the event the application does not contain specific speech recognition modules necessary for wireless callers). Finally, in the event the callback number does not return 812 a valid customer profile 814 from the backend database (or from appropriate third party name & address databases), the caller is sent 806 to a human agent for further processing. If the caller passes all the various checks, then the caller continues 820 with additional steps to order a vehicle.

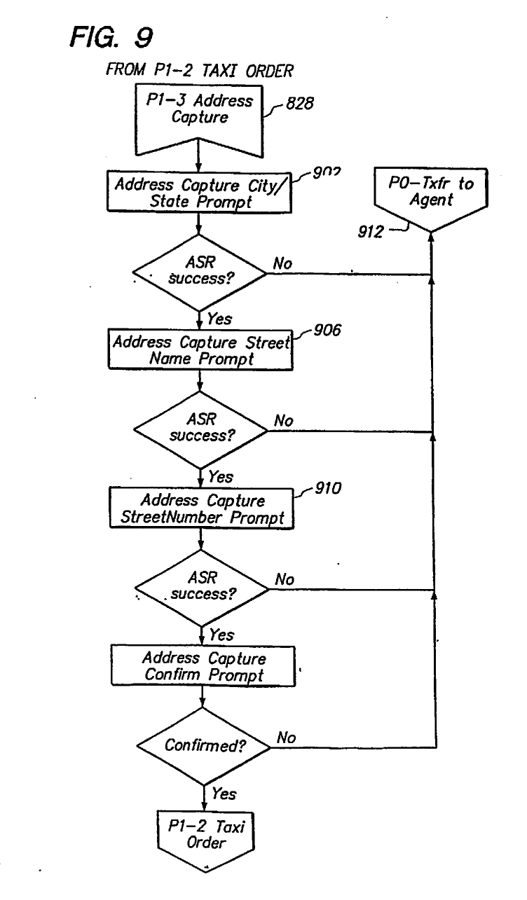

FIG. 8B illustrates a second series of steps used to place an order for a vehicle in accordance with an embodiment of the present invention, and continuing where FIG. 8A left off. Using the ANI or caller-entered Callback Number, a query is made 822 of either a centralized repository or end client back-end database of customer names, addresses, and other rider information 824. The address is retrieved and then read to the caller using pre-recorded audio files or text-to-speech (TTS). Information retrieved from the database is then either confirmed or rejected 826 by the caller using DTMF or yes/no voice confirmation. In the event the address is rejected, the caller may be given 828 the option of entering a new address, as described below with respect to FIG. 9.

Next, if the caller requests an immediate pickup 830, information captured from the caller is then transmitted 832 to the interface server for input into the legacy dispatch or booking system. Upon successful input, the interface server retrieves a confirmation number and estimated time of arrival (ETA) from the backend database (and/or other appropriate confirmation information, such as vehicle number, driver number and name, confirmation callback number, and so forth) and reads the information to the caller. In the event some or all of this information is not available from the backend system, the interface server may generate its own confirmation information as needed.

The caller is then asked 834 to provide any additional information needed by the particular enterprise including, for example, payment type (including associated information, such as credit card number, voucher number, expiration date, etc.); vehicle type; destination address; special needs (wheelchair-enabled vehicle, child seat, etc.); and so forth.

If the caller did not want an immediate pickup 830, but instead wanted to schedule a reservation for a future pickup, the system additionally prompts the user for an hour 840, minute 842, and time-of-day (AM/PM) 844 at which the user would like to get picked up. Flow then proceeds to the fleet dispatch step 832 as described above.

FIG. 9 illustrates capturing a pickup address by speech server 110. The caller is in turned queried for city/state 902, street name 906, and street number 910. If the address capture fails at any of the steps, the caller is transferred 912 to an agent 130. In an alternative embodiment, the caller says his pickup location, preferably by “Quick Name” (e.g., Home, Work, Hospital, Library, Park, Football Stadium, Freshfields, etc.). For example, the following mapping from Quick Names to Actual Names could exist:

| Quick Name | Actual Name |
|---|---|
| Home | 123 Pound Street |
| Work | 224 Abbey Road |
| Franklin Park | 1062 Kings Manor Drive |

In this alternative embodiment, the caller can choose from a list of choices presented from prior rides. In order to speed the process, the caller first hears the address linked to the caller ID previously entered. Once a caller chooses from the list for the first time, he or she is asked to say a “Quick Name” for that location, which is stored for future use. This process can also occur via registration with a live operator—for instance, after the order was completed.

The caller can then say his or her destination in a similar manner. The system can also store pre-set trips by name, e.g., Morning ride, Evening ride, etc., which automatically enters pickup and set-down locations.

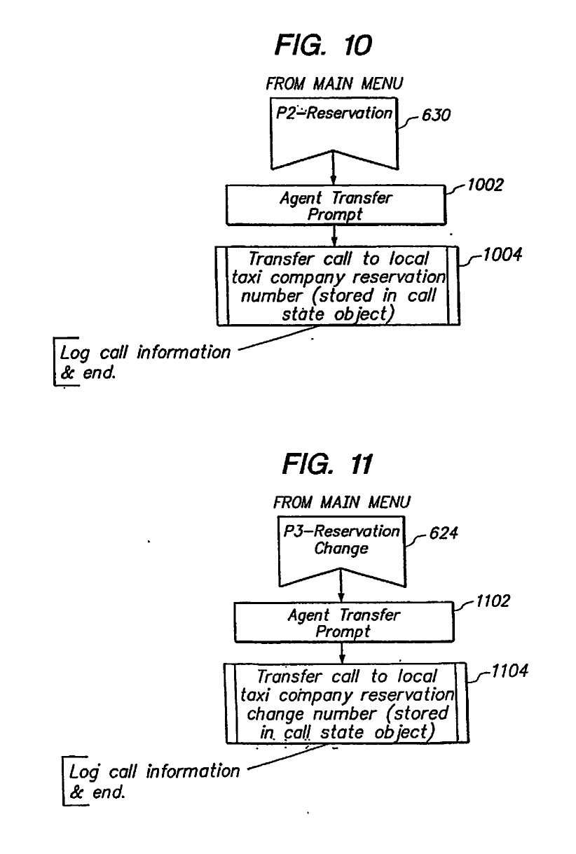

FIGS. 10-13 illustrate various transfers to an agent 130 for advance reservations, reservation changes, and to customer service. When a caller is transferred, if the back-end dispatch system supports it, all of the data captured by the system may be transferred to the agent's screen via “screen-pop” functionality. FIG. 10 illustrates one embodiment where, when a caller decides during the reservation phase 630 to make a reservation more than 24 hours in advance, the caller is transferred to a live agent 1004, after optionally prompting 1002 the caller. This provides support for systems that do not support computerized reservations made more than one day ahead of pickup time.

In FIG. 11, when a caller selects a reservation change 624, the caller is sent 1104 to an agent 130 via transfer prompt 1102. In an alternative embodiment a set of prompts and dialogs allows for a reservation change, including prompts for changing time of pickup, day of pickup, number of vehicles, and so forth.

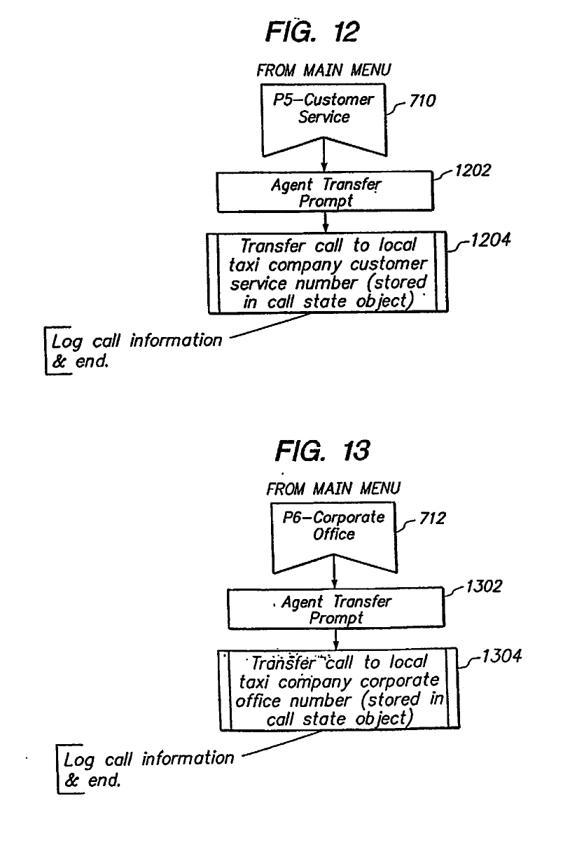

Referring now to FIG. 12, when a caller requests customer service 710, the caller is transferred 1204 to an appropriate agent 130 in a customer service workgroup or ACD group via transfer prompt 1204. This is typically accomplished by the speech server 110 instructing the telephony gateway 108 to transfer the caller to a particular ACD/workgroup extension.

In FIG. 13, when a caller chooses to connect to the corporate offices 712, the speech server 110 via the telephony gateway 108 transfers 1304 the caller via transfer prompt 1302 to a particular extension or phone number associated with the main corporate office.

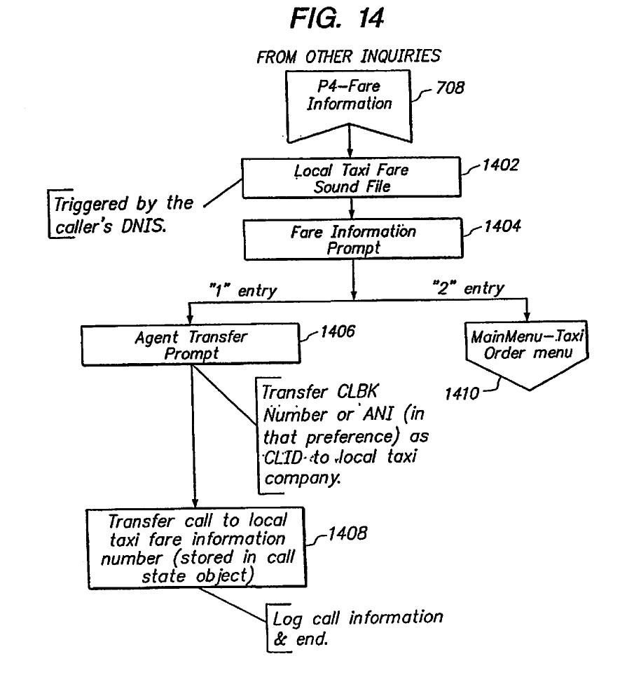

FIG. 14 depicts a method of providing fare information to the caller. When a caller selects 708 the fare information option, typically a single sound file will played 1402 to the caller, specifying general information, such as flag fares, distance fees, time fees, extras, and other appropriate information. In one embodiment, a destination address is captured from the caller, in order to provide a more exact fare using mapping tools to calculate an estimated travel distance and time. Once the fare information is provided, the caller is provided with the fare information prompt 1404, from which he may access the agent transfer prompt 1406 to be transferred 1408 to an agent 130, or he may choose to return 1410 to the main menu. Note that fare information can be provided to the caller in response to address information captured using DTMF entries, speech recognition, or can alternatively be provided online in response to information input, e.g., via a keyboard.

As will be recognized by those of skill in the art, other call flows may be constructed based upon standard types of passenger ground transportation transactions. For instance, in addition to the ability for callers to phone into the system to check the status of a ride, the automated system could initiate outbound phone calls, e-mails, or pages upon confirmation of booking, when the vehicle is 10 minutes away, 5 minutes away, at the destination point, etc. Additionally, passengers can say “cancel” upon receiving the notification to easily cancel a ride. Each user can edit outbound notification profiles either via a web, phone, or other suitable interface. In another example, for account-based patrons, clients can be given specialized dial-in numbers (local or toll-free) that are customized to their desires and corporate culture. Call flows might include employee number, billing numbers, and stored vehicle preferences. Call flows for airport shuttles, including airport, airline, and flight no., or for paratransit rides, including voucher authorization, disability-related factors, and other relevant information, are also suitable for the present invention.

### Speech Recognition

Overview

Speech server 110 uses speech recognition and touchtone in order to collect information. Similarly, speech recognition may be utilized to determine fares and perform payment processing functions as described above. The speech recognition is typically driven by an application written in the standard voice eXtensible Markup Language (vXML), though other languages may be used, as will be recognized by those of skill in the art.

Using conventional speech recognition “grammars,” such as from Nuance, Speechworks, for example, speech server 110 has the ability to recognize numbers, “yes”/“no”, city names, state names, street names, airport names and other landmarks, vehicle types (e.g., taxi, cab, limo, limousine, shuttle, etc.), payment information, special needs (e.g., premium vehicle or paratransit/wheelchair), and voice prints to more accurately identify callers. This recognized information is converted into data and transmitted to the call taking and fleet dispatching platforms 120 as appropriate.

Enhanced Recognition of Locations

Speech server 110 preferably incorporates algorithms that supplement the standard ASR process by providing for post-utterance algorithms that allow the speech server 110 to intelligently choose among the thousands of potential choices. These algorithms mimic the human process of using context to determine the exact word corresponding to an utterance. By adding “intelligence” to the speech selection process in this manner, the present invention improves current accuracy levels.

Description of the Algorithms

In one embodiment, a first stage in implementing the algorithm is to set a speech engine, which resides on speech server 110, to return a list of potential matches (an “N-best list”) of the spoken utterance along with the speech engine's best guess probability of a particular word being the correct target. The following table provides an example:

| Guess | Probability |
|---|---|
| Mark | 50% |
| Match | 33% |
| More | 5% |
| Many | 4% |
| Made | 3% |
| Manner | 2% |
| Mast | 1% |
| Mall | 1% |
| Mary | 1% |

The generation of the N-best list is preferably determined based upon the analysis of the sound wave associated with a particular utterance. In a preferred embodiment, such a determination is made by comparing parts of the sound wave to particular phonemes that may match such parts. Based upon conventional statistical formulas from vendors such as Nuance and Speechworks, possible guesses for the utterance are returned with their associated accuracy probabilities. In the illustration above, ten words are returned as a potential match—in many situations, fewer or more words may be optimal depending upon the overall size of the speech grammar.

After the N-best list is returned, a post-utterance algorithm is used to re-weight the probability figures generated in the N-best list. In one embodiment, the following attributes are used to determine whether the N-best list probabilities generated by the speech software should be re-weighted:
Specific Client Profile History: Examination of a caller's past ordering history will enable the system to make intelligent guesses about which results of a N-best list are acceptable. For instance, if a caller has ordered a vehicle from Match Street the last ten trips, then the word “match” will receive higher weighting than the word “Mark”. The probabilities generated by the N-best list are re-weighted accordingly. Suitable indicators for dispatch-related applications include:
   Prior pickup and drop-off locations including street name, street number, city and relevant time of day, day of week, and other temporal qualities of those addresses.
   Other relevant indicators of past usage such as credit card number, voucher number, type of vehicle, and the like, that are linked to a particular caller's telephone number.
General Clientele Order History: In addition to a specific caller's ordering history, the post-utterance algorithm examines an entire set of callers' (i.e., a clientele's) ordering history. The same types of factors noted above are examined, but on a statistical basis across all callers.
Geographic Location of Caller: The geographic location of the caller may often be pinpointed or determined generally. This information can be used to guess at a caller's pickup or drop-off location. Specifically, results of an N-best that are near to a caller (especially for a pickup) are re-weighted with a higher probability.

Form of the Algorithms

Each return in the N-best list is examined against a set of various criteria. For instance, taking the word “match” above, and assuming it is uttered for a pickup address, the invention determines whether it meets any of the following criteria, and if so, with what regularity.
Previous pickup Address of caller? Yes/No? What percentage of time?
Previous pickup address of any caller? Yes/No? What percentage of time?
If previous pickup address of caller, what percentage of time during +/−3 hr. period?
If previous pickup address of any caller, what percentage of time during +/−3 hr. period?
How far is pickup address from location of caller as determined by caller ID reverse match (if available)? If not available, how far is pickup address from center of zip code of reverse match (if available)?

The preceding percentages and distances are preferably substituted into an algorithm that is optimized over time in a neural network-type fashion to return optimal responses. First, each potential response is re-weighted. Then all responses values are normalized to return an overall value of 100%. At that point, an algorithm of the speech engine running on the speech server 110 searches for matches over an acceptable probability threshold—preferably, 85% or higher. If there is no re-weighted result that returns such a probability, then the speech server 110 reads to the caller multiple acceptable choices. The user either states one of them, or says “none”. If the user says “none”, then the user can be queried again for a response, or transferred to an agent for further assistance.

By using the speech engine's post-utterance algorithms to perform additional analysis on spoken utterances, it is possible to achieve much higher accuracy rates than typical with conventional acoustical model-only analysis, thereby enabling cost-effective location-based speech recognition packages.

### Databases

In one embodiment, a number of databases store information in system 100 or third-party systems.

First, system 100 either houses and/or is able to access databases located in a back-end booking system 120, including in a preferred embodiment a company customer profile information database 124 and a billing/cashiering database 126. The company customer profile information database 124 stores customer names, telephone numbers, addresses, special needs, etc., while the billing billing/cashiering database 126 stores voucher/billing/payment information, previous trips, preferred/non-preferred drivers, preferred/non-preferred vehicles, etc. Those of skill in the art will recognize that customer profile and billing information can be storied in a variety of ways, both logically and physically. The Customer Profile Database typically includes data collected from clients. Additionally, any new data entered at dispatcher centers is transferred to the Customer Profile Database 124 on a real-time or periodic basis. Additionally, customers may register Customer Profile Data via phone (automated or with a customer service representative (CSR)), online, or wirelessly via PDA or wireless-web enabled phone.

System 100 additionally has access in real-time to information stored in either the system's or third-party fleet dispatching systems 122 including, for example: vehicle location, vehicle type (including make and model), vehicle drivers, vehicle availability, ETA's and wait times, shared ride information, estimated trip time, estimated fare, voucher/billing information, flight information, and the like. This information is used to allow the customer and back-end booking and reservations system, part of the fleet dispatch system 122, to make informed and intelligent decisions when booking a trip. Additionally, the information is used to provide the customer with status reports from the time the order is placed to the pickup, as well as real-time status reports about ETAs that the customer may transmit to third parties or allow third parties to access. Similarly, either through automated outbound calls to a customer or from an inbound call, the customer is able to easily cancel or change the details of an order without the need to speak to a dispatch or call center agent 130. The system is also able to access information inputted via an in-vehicle electronic media device. This information might include quality surveys filled out by the customer during the ride and/or preferences chosen during the ride (e.g., listing the driver as a preferred/non-preferred driver, listing the vehicle as preferred/non-preferred, etc.).

Third, a cross-reference of dialed numbers (DNIS) to regional transportation service providers is preferably maintained. There are several attributes used to maintain the relationship with each transportation service provider. This list includes phone numbers, contacts, IP addresses, circuit ID's, and various system management and control flags (e.g., auto-confirmed Dispatch Requests). This database is also utilized by the main call flow logic application residing speech server 110.

### Interface Server & Middleware

Overview & API Description

In order to seamlessly integrate with existing, multiple back-end dispatch architectures 120, system 100 includes robust middleware, which allows for connectivity in real-time to various databases. The middleware contains components specifically tailored for integration to legacy dispatch architectures widely present in the transportation industry.

Referring again to FIGS. 1 and 2, two components are preferably included in the middleware: a central booking server 210 (which is an application server as described in FIG. 2), which acts a go-between among the several components and stores data; and interface server 118, which integrates directly to the legacy dispatch system 120. The central booking server 210 also connects to speech server 208, which controls the overall application and call flow. The central booking server 210 may be located on-site at the transportation company or off-site, as depicted in FIG. 2.

In a preferred embodiment, central booking server 210 performs several functions. First, it handles rider profile requests from the speech server 110, wherein as described in FIG. 8A, rider information is retrieved based upon an entered account or telephone number. Second, it receives and transmits information to and from the interface server 118. This effectively enables the real-time exchange of information between caller and back-end dispatch system 120. Third, it performs database caching functions, storing rider profile information and other data in order to speed the process of call flows. A legacy application synchronizer (LAS) software component performs a periodic importation process to keep the data current in both the database cache and back-end dispatch system database. Fourth, the central booking server 210 monitors the links between the interface server 118 and speech application server 110.

The interface server 118 also preferably performs several additional functions. First, it polls rider profiles from the legacy dispatch systems. Second, it receives orders from central booking server 210. Third, it translates orders from the standard dispatch API, described below in the “Legacy Application Bridge” section, to the legacy language. Fourth, it places orders into legacy systems. The interface server 118 uses an appropriate set of fields present in the legacy dispatch system and uses a master API, described below, which encompasses the relevant fields to perform two-way translation between the central booking server and legacy dispatch systems.

To achieve robustness with integration to multiple back-end databases, a simple, yet scaleable API is used for server-to-server communication prior to translation at the Interface Server 118. The first is a “Rider Booking” API, which performs a request for a rider's profile. The following illustrates an example of an XML version of the API, although alternative approaches are feasible.

<!ELEMENT RiderBooking(Version, ANI, DNIS, CallbackNumber)-->
<!--Document Version-->
<!ELEMENT Version #PCDATA>
<!--Ride Request Phone Number Dialed -->
<!ELEMENT DNIS #PCDATA>
<!--Ride request phone number -->
<!ELEMENT ANI #PCDATA>
<!--Number Rider can be contacted at -->
<!ELEMENT CallbackNumber #PCDATA>
<!-- End RiderBooking.dtd -->
]>

The next element is labeled “RiderBooking Profile” and contains the API necessary to return a valid response to the RiderBooking request. An XML example of the API is provided as follows:

<!ELEMENT RiderBookingProfile (Version, InquiryAttributes,
Response)>
<!--Document Version-->
<!ELEMENT Version #PCDATA>
<!--Inquiry Attributes-->
<!ELEMENT InquiryAttributes(ANI, DNIS, CallbackNumber)>

<!-- Ride request phone number -->
<!ELEMENT ANI #PCDATA>
<!-- Ride request phone number dialed -->
<!ELEMENT DNIS #PCDATA>
<!-- Number rRider can be contacted at -->
<!ELEMENT CallbackNumber #PCDATA>

<!-- Response includes Rider Data or System Error Message

explaining what went wrong -->

<!ELEMENT Response(SystemMessage | RiderData)>
<!ELEMENT SystemMessage(Code, Description)>

<!-- Possible SystemMessage Codes

401 - Unable to connect to Central Server Data Center
402 - Central Server connection timeout
403 - Central Server connection timeout after connect
404 - Record not found in Dispatch System
405 - etc...

-->
<!ELEMENT Code #PCDATA>
<!ELEMENT Description #PCDATA>

<!ELEMENT RiderData(RiderID, PickupLocation*,

CreditCardDetails, RiderDetails)>

<!-- Database Primary Key for Rider Table -->
<!ELEMENT RiderID #PCDATA>
<!-- Previous Pickup Addresses: This is used to allow

multiple pickup addresses -->

<!-- PickupAddressAudium new address for audio file-->
<!ELEMENT PickupLocation(PickupLocationID,

PickupLandmark, PickupAddressAudium, PickupAddress1,
PickupAddress2, PickupAddress3, PickupUnit,

PickupCity, PickupState,

PickupZip)>

<!ELEMENT PickupLocationID #PCDATA>
<!ELEMENT PickupLandmark #PCDATA>
<!ELEMENT PickupAddressAudium #PCDATA>
<!ELEMENT PickupAddress1 #PCDATA>
<!ELEMENT PickupAddress2 #PCDATA>
<!ELEMENT PickupAddress3 #PCDATA>
<!ELEMENT PickupUnit #PCDATA>
<!ELEMENT PickupCity #PCDATA>
<!ELEMENT PickupState #PCDATA>
<!ELEMENT PickupZip #PCDATA>

<!-- Credit Card Information -->
<!ELEMENT CreditCardDetails(CCType, CCNumber,

CCExpiration, BillingAddress1, BillingAddress2,

BillingCity, BillingState,

BillingZip)>

<!ELEMENT CCType #PCDATA>
<!ELEMENT CCNumber #PCDATA>
<!ELEMENT CCExpiration #PCDATA>
<!ELEMENT BillingAddress1 #PCDATA>
<!ELEMENT BillingAddress2 #PCDATA>
<!ELEMENT BillingCity #PCDATA>
<!ELEMENT BillingState #PCDATA>
<!ELEMENT BillingZip #PCDATA>

<!ELEMENT RiderDetails(SpecialNeeds,
PickupInstructions)>

<!ELEMENT SpecialNeeds #PCDATA>
<!ELEMENT PickupInstructions #PCDATA>

<!-- End RiderBookingProfile.dtd -->

The third element is termed “Booking Request” and performs a request for a booking via the Central Booking Server and subsequently the Interface Server 118 for necessary translation into the back-end legacy dispatch system. An XML example of the API is as follows:

<!ELEMENT BookingRequest (Version, ANI, DNIS,

CallbackNumber, RiderID, PickupData, PickupTime,

PickupLocation, DropoffLocation, TransactionData,

CreditCardDetails, RiderDetails, PartialOrder*)>

<!ELEMENT Version #PCDATA>
<!ELEMENT ANI #PCDATA>
<!ELEMENT DNIS #PCDATA>
<!ELEMENT CallbackNumber #PCDATA>
<!ELEMENT RiderID #PCDATA>
<!-- Pickup Date in the format of MM/DD/YYYY-->
<!ELEMENT PickupDate #PCDATA>
<!-- Pickup Time in the format HH:MM -->
<!ELEMENT PickupTime #PCDATA>
<!ELEMENT PickupLocation(PickupLocationID, PickupLandmark,

PickupAddress1, PickupAddress2, PickupAddress3, PickupUnit,
PickupCity,

PickupState, PickupZip, ZoneInformation)>

<!ELEMENT PickupLocationID #PCDATA>
<!ELEMENT PickupLandmark #PCDATA>
<!ELEMENT PickupAddress1 #PCDATA>
<!ELEMENT PickupAddress2 #PCDATA>
<!ELEMENT PickupAddress3 #PCDATA>
<!ELEMENT PickupUnit #PCDATA>
<!ELEMENT PickupCity #PCDATA>
<!ELEMENT PickupState #PCDATA>
<!ELEMENT PickupZip #PCDATA>
<!ELEMENT ZoneInformation(ZoneLatitude, ZoneLongitude)>

<!ELEMENT ZoneLatitude #PCDATA>
<!ELEMENT ZoneLongitude #PCDATA>

<!ELEMENT DropoffLocation(DropoffLocationID,

DropoffLandmark, DropoffAddress1, DropoffAddress2, DropoffAddress3,
DropoffUnit,

DropoffCity, DropoffState, DropoffZip)>

<!ELEMENT DropoffLocationID #PCDATA>
<!ELEMENT DropoffLandmark #PCDATA>
<!ELEMENT DropoffAddress1 #PCDATA>
<!ELEMENT DropoffAddress2 #PCDATA>
<!ELEMENT DropoffAddress3 #PCDATA>
<!ELEMENT DropoffUnit #PCDATA>
<!ELEMENT DropoffCity #PCDATA>
<!ELEMENT DropoffState #PCDATA>
<!ELEMENT DropoffZip #PCDATA>

<!ELEMENT TransactionData(TransactionType, VoucherNumber,

CouponCode)>

<!ELEMENT TransactionType #PCDATA>
<!ELEMENT VoucherNumber #PCDATA>
<!ELEMENT CouponCode #PCDATA>

<!ELEMENT CreditCardDetails(CCType, CCNumber, CCExpiration,

BillingAddress1, BillingAddress2, BillingCity,

BillingState, BillingZip)>

<!ELEMENT CCType #PCDATA>
<!ELEMENT CCNumber #PCDATA>
<!ELEMENT CCExpiration #PCDATA>
<!ELEMENT BillingAddress1 #PCDATA>
<!ELEMENT BillingAddress2 #PCDATA>
<!ELEMENT BillingCity #PCDATA>
<!ELEMENT BillingState #PCDATA>
<!ELEMENT BillingZip #PCDATA>

<!ELEMENT RiderDetails(SpecialNeeds, PickupInstructions)>

<!ELEMENT SpecialNeeds #PCDATA>
<!ELEMENT PickupInstructions #PCDATA>

<!-- This will be used by true for a partial order or false or

missing for otherwise -->

<!ELEMENT PartialOrder #PCDATA>
<!-- End BookingRequest.dtd -->

The final set of API's are termed “BookingRequestResponse” and provide a confirmation that a successful transaction has been completed vis-à-vis the central booking server, Interface Server, and back-end dispatch system. An XML example of the API is as follows:

<!ELEMENT BookingRequestResponse (Version, ErrorCode,

ErrorDescription, OrderConfirniation)>

<!ELEMENT Version #PCDATA>
<!-- System Generated Error Code -->
<!ELEMENT ErrorCode #PCDATA>
<!--System Generated Error Description-->
<!ELEMENT ErrorDescription #PCDATA>
<!-- Confirmation Number generated by the Interface
system -->
<!ELEMENT OrderConfirmation(CompanyName, Service,

CallNumber, CompanyAgentPhone, ETA)>

<!ELEMENT CompanyName #PCDATA>
<!-- Type of Service being provided Cab, Limo, Van
-->
<!ELEMENT Service #PCDATA>
<!-- The order Confirmation Number -->
<!ELEMENT CallNumber #PCDATA>
<!-- A number to reach an agent -->
<!ELEMENT CompanyAgentPhone #PCDATA>
<!-- Estimated Time of Cab Arrival -->
<!ELEMENT ETA #PCDATA>

<!-- End BookingRequestResponse.dtd -->

Legacy Application Bridge

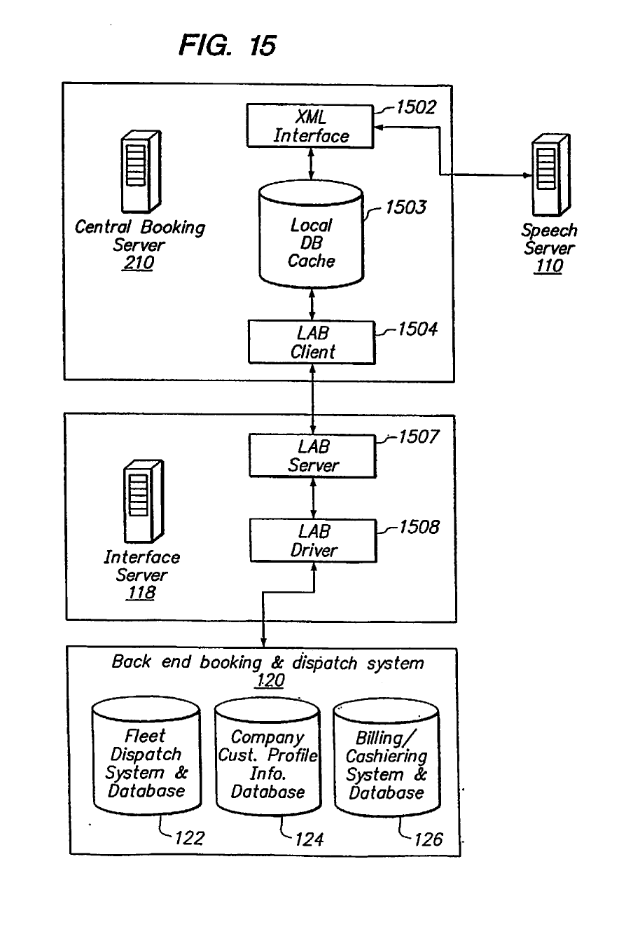

In order for the interface server 118 to successfully translate legacy data to and from the API in real-time, as described in FIG. 15, “Legacy Application Bridge” (LAB) software architecture is implemented. The LAB adds the modern capabilities of XML, vXML and Internet-enabled architectures to platforms previously incapable of supporting such technologies. A preferred embodiment uses the Microsoft Windows 2000 Platform with VB/COM, Java, XML and SQL technologies (though any other suitable operating system and development environment could be used to implement the LAB). By using the best-of-breed technologies, the system enables a cross-platform, modular, scalable LAB interface that can connect to many different types of environments and platforms. This type of hybrid approach to design lowers the overall cost of technology implementation while providing many of the same benefits and features found in more narrow off-the-shelf packages. This system also allows for “rolling-forward” to newer technologies, thereby streamlining the migration process to a modern end-to-end solution.

In one embodiment, the LAB includes four major components. First, an “XML Interface” 1502 or other suitable API Interface, which resides on the central booking server 210 and parses the standard four API's described above, which are transmitted to and from the speech server 110. In particular, the XML Interface 502 parses the requests and transmittals described in the above mentioned APIs (i.e., RiderBookinglnquiry, RiderProfile, RiderBooking, and RiderBooking Response), interfaces with the local patron cache database 1503, transmits the request to the “LAB Client” 1504 (defined below) as required, and logs transactions. Second, the LAB Client 1504, which resides on the central booking server. Specifically, the LAB Client receives requests from the XML Interface, interfaces with the “LAB Server” 1507 (defined below), provides responses from LAB Server to XML Interface, and monitors the LAB Server. Third, the LAB Server, which resides on the Interface Server 118. Specifically, the LAB Server receives requests from the LAB Client, parses for the local back-end legacy environment, interfaces with the LAB Driver 1508 (defined below), and logs transactions. Finally, the LAB Driver 1508, which also resides on interface server 118. Specifically, the LAB Driver receives requests from the LAB Server, posts to the legacy dispatch system database, and provides responses to LAB Server.

The LAB Driver 1508 contains components to coordinate a set of open application programming interfaces (APIs) used by the speech server 110 and typically, a set of proprietary database tables and fields resident on the back-end booking and dispatch system 1509. Fields of the API are those conventionally used in the ground transportation industry to store customer profile information, book orders, dispatch orders, retain status information, process financial information, track vehicles, schedules drivers, recall orders, cancel orders, and so forth. These fields are matched via conventional integration methods against the proprietary fields of the third-party back end booking & dispatch system 120 in order to enable real-time communications between the LAB and the back-end system.

### Logging

In order to provide complete reporting to clients and to improve system performance through analysis of customer interactions, the system preferably creates a detailed log, in the format of a comma-delimited file, which includes application transactions. A web-based reporting tool is made available for clients to log into to view their reports on a periodic or real-time basis.

The following are example requirements for the application log:

Application Log Structure

| Field | |
|---|---|
| Column | Set CDR Field |
| 1. | Call Session ID |
| 2. | Abandoned/Dropped Call = 1 (not incremented) - |
| | Developer note. If the call is not abandoned or dropped, |
| | this should be set to 0. The same is true for all similar |
| | log fields. If not applicable, set to 0. |
| 3. | DateTimeStamp Call Start |
| 4. | DateTimeStamp Call End Inbound - This field is used to |
| | capture the timestamp before bridging the call |
| 5. | DateTimeStamp Call End - This field is used to capture |
| | the timestamp when the call is ended. It is not shown on |
| | the flow, as it can occur at any time. |
| 6. | Inbound Duration - Calculated field capturing total time |
| | in IVR before bridging call. Specify in seconds, if |
| | possible. If not, specify in MM:SS format. |
| 7. | Outdial Duration - Calculated field capturing total time |
| | of bridged part of call. Specify in seconds, if possible. If |
| | not, specify in MM:SS format. |
| 8. | Total Call Duration - This field is the total call duration, |
| | inclusive of IVR and bridged call times. |
| 9. | DNIS |
| 10. | ANI of caller |
| 11. | Callback Number (if entered) |
| 12. | City (from POSTAL_CODE TABLE) |
| 13. | State (from POSTAL_CODE TABLE) |
| 14. | Country (from POSTAL_CODE TABLE) |
| 15. | 16 digit Postal code (from POSTAL_CODE TABLE) |
| 16. | Menu 12: CED (number) |
| 17. | Menu 12: CED (name: e.g., Same-day Order, Reservation, |
| | etc.) |
| 18. | Outdialed Number |
| 19. | Trans. company name (from Trans. Company Database) |
| 20. | No Answer = 1 (not incremented) |
| 21. | Busy = 1 (not incremented) |
| 22. | Invalid = 1 (not incremented) |
| 23. | Timeout = 1 (not incremented) |
| 24. | No ANI Flag = (set to 1 for true, 0 for false) [set if |
| | incoming caller has no ANI for internal purposes only] |
| 25. | No ANI = 1 (not incremented) |
| 26. | No ANI NpaNxx Flag = (set to 1 for true, 0 for false) [set if |
| | the NPA-NXX of caller's ANI is not in NPA-NXX |
| | database] |
| 27. | No ANI Postal Flag = (set to 1 for true, 0 for false) [set if |
| | NPA-NXX of caller returned by ANI does not return a |
| | valid postal code] |
| 28. | ANI Wireless Flag = (set to 1 for true, 0 for false) |
| 29. | CLBK Wireless Flag = (set to 1 for true, 0 for false) |
| 30. | ANI_Not_in_CPDB = 1 (set if caller id is not in Customer |
| | Profile DB) [for internal purposes only] |
| 31. | No_ANI_CLBK_Match = 1 (if NPA-NXX of CLID and |
| | CLBK number do not match) |
| 32. | CLBK_Not_in_CPDB = 1 (set if callback number is not in |
| | Customer Profile DB) |
| 33. | CLBK_Not_in_NPA-NXX = 1 (set if callback number is |
| | not in NPA-NXX database) |
| 34. | No CLBK Postal Flag = (set to 1 for true, 0 for false) [set if |
| | NPA-NXX of caller returned by CLBK does not return a |
| | valid postal code] |
| 35. | Cust DB Street Number [log information pulled from |
| | Customer Profiled database re caller's whereabouts] |
| 36. | Cust Landmark (if available) |
| 37. | Cust Specific Landmark (if available) |
| 38. | Cust DB Street |
| 39. | Cust DB City |
| 40. | Cust DB State |
| 41. | Cust DB Zip |
| 42. | Input Pick Up Street Number [log information as to |
| | where caller actually wants to be picked up (duplicate |
| | 41-44 if caller makes no other specification)] |
| 43. | Input Pick Up Street |
| 44. | Input Pick Up City |
| 45. | Input Pick Up State |
| 46. | Input ZIP (we will pull this from external sources - |
| | Telivigation) |
| 47. | Guessed ZIP (based on NPA-NXX) |
| 48. | Operator = 1 (set to 1 if caller presses 0) |
| 49. | Call Flow Operator (we will specify letters to indicate |
| | point in call flow where caller hits 0, if applicable) |
| 50. | Immediate Service = 1 (set to 1 if caller orders same-day |
| | taxi service for immediate service, otherwise set to 0) |
| 51. | Time of Service Call (in MM:YY (24-hour time)) if caller |
| | books a reservation |
| 52. | Date of Order (if caller orders a vehicle, set |
| | mm/dd/yyyy) |
| 53. | Termination State-signifies if call ends in IVR or with |
| | agent |

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. For example, the particular functions of the central booking server 210, interface server 118, speech server 110, telephony gateway 108, and so forth may be provided in many or one module.

Some portions of the above description present the feature of the present invention in terms of algorithms and symbolic representations of operations on information. These algorithmic descriptions and representations are the means used by those skilled in the casino management arts to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

1-2. (canceled)

3. A system to place orders for taxicab service over a telephony communications network comprising:
a server having DTMF recognition software to recognize caller-entered input and speech recognition software to recognize caller-spoken words; and
software executed on the server to provide call flow logic for placing service orders for taxicab service in response to the recognized caller-entered input;
wherein the software places service orders for taxicab service in response to recognized caller-spoken words as well as caller-entered input.

4. The system of claim 3, further comprising a real-time application programming interface from the server to a taxicab dispatch or reservation database.

5. The system of claim 3, further comprising a real-time interface to integrate the server to a PBX or other telephone system.

6. A method to place orders for transportation service over a telephony communications network comprising:
(a) recognizing via speech recognition or touch-tone entry an ANI, CLID, or DNIS of a caller who connects to an interactive voice response system that is interfaced in real-time with a separate PBX or other telephone system by calling one or more telephone numbers;
(b) recognizing location information of the caller derived from the information provided in step a; and
(c) generating a service order for a taxicab, sedan, or black car in response to actions of the caller or transferring the caller to a live agent.

7. The method of claim 6, wherein:
the interactive voice response system is interfaced to a dispatch or scheduling database in real-time.

8. The method of claim 6, further comprising:
recognizing account numbers or voucher numbers via speech recognition or touch-tone entry from the caller on the interactive voice response system.

9. The method of claim 6, further comprising:
determining whether the caller is connecting to the interactive voice response system from a wireless device.

10. The method of claim 6, wherein transferring the caller is triggered based upon one or more of the caller's ANI, CLID, DNIS, type of device, caller-entered digits or speech responses, a caller database profile, or a lack of a record in a dispatch or scheduling database.

11. The method of claim 6, wherein the one or more telephone numbers used by the caller to connect to the interactive voice response system are the same telephone number or numbers used for service orders not automated by DTMF or speech recognition.

12. The method of claim 6, further comprising:
communicating details of the service order to an in-vehicle wireless device comprising a mobile data terminal.

13. The method of claim 6, further comprising:
processing at least 20% of all incoming calls for service orders on a monthly basis according to steps (a)-(c).

14. A method to place orders for transportation service over a telephony communications network comprising:
establishing and maintaining a real-time interface with a PBX or other telephone system;
automatically recognizing a caller's input;
establishing and maintaining a real-time interface with a transportation reservation or dispatch system;
using an automated set of steps of call flow logic to process caller input and request additional caller input to derive data necessary for placing an order for transportation by a transportation service, the call flow logic including:
responding to the recognized caller input by determining a preferred path within the call flow logic in accordance with data derived from the caller;
automatically requesting additional data selected in accordance with any data previously derived from the caller;
determining a further preferred path within the call flow logic in accordance with any data received from the transportation dispatch system;
determining a further preferred call path in response to data derived from a database including historical data related to the transportation dispatch system in response to information obtained from the caller; and
generating a service order for a taxicab, sedan, or black car in the transportation reservation or dispatch system.

15. The method of claim 14, wherein the real-time interface to the transportation reservation or dispatch system is established and maintained using a global application programming interface that interfaces with a third-party transportation reservation or dispatch system.

16. The method of claim 14, wherein middleware translates third-party data to and from the global application programming interface in real-time.

17. The method of claim 14, further comprising performing a screenpop of the ANI, CLID, or data captured from the caller on the live agent's screen upon transfer of the caller.

18. The method of claim 14, wherein the set of steps of call flow logic contains rules that automatically transfer a caller to a live agent based upon a caller's ANI, CLID, DNIS, type of device, caller-entered digits or speech responses, a caller database profile, or a lack of a record in the dispatch or scheduling database.

19. The method of claim 14, wherein the caller connects to the real-time interface using a telephone number that the transportation company uses for service orders not automated by DTMF or speech recognition.

20. The method of claim 14, further comprising communicating details of the service order to an in-vehicle wireless device.

21. A system to provide information over a telephony communications network comprising:
a set of machine-readable instructions on a machine-readable medium interoperable with a machine to provide call flow logic used to notify users of information related to pending taxicab service orders;
a real-time interface to a dispatch or scheduling database; and
interface hardware and middleware software executed on the interface hardware or on another machine to integrate to a PBX or other similar telephone system.

22. A method to place orders for transportation service over a telephony communications network comprising:
(a) establishing and maintaining a real-time interface between an interactive voice response system and a separate PBX or other telephone system;
(b) recognizing or confirming via speech recognition or touch-tone entry an ANI, CLID, or location information of a caller on the interactive voice response system;
(c) generating a service order for a taxicab, sedan, or black car in response to the actions of the caller.

23. The method of claim 22, further comprising:
interfacing the interactive voice response system to a dispatch or scheduling database in real-time.

24. The method of claim 22, further comprising:
recognizing account numbers or voucher numbers via speech recognition or touch-tone entry from a the caller on the interactive voice response system.

25. The method of claim 22, further comprising:
determining whether the caller is connecting to the interactive voice response system from a wireless device.

26. The method of claim 22, wherein the caller is selectively transferred to a live agent based upon the caller's ANI, CLID, DNIS, type of device, caller-entered digits or speech responses, a caller database profile, or a lack of a record in the dispatch or scheduling database.

27. The method of claim 22, wherein the interactive voice response system is accessible via one or more telephone numbers and those one or more telephone numbers are also used for service orders not automated by DTMF or speech recognition.

28. The method of claim 22, further comprising communicating details of the service order to an in-vehicle wireless device.
